(19) United States
(12) Patent Application Publication
(10) Pub. No.: US 2012/0228463 A1
(43) Pub. Date: Sep. 13, 2012

(54) TENSION ADJUSTMENT MECHANISM AND METHOD

(75) Inventors: Troy A. Nelson, Carlton, OR (US); Dave Terrill, Newberg, OR (US)

(73) Assignee: Dental Components LLC

(21) Appl. No.: 13/044,004

(22) Filed: Mar. 9, 2011

(51) Int. Cl. F16H 25/20; F16M 13/02; F16M 13/00

(52) U.S. Cl. 248/578; 74/89.23

(57) ABSTRACT

Embodiments of the present invention are related to tension adjustment for a tension spring in a flex arm. Example embodiments include a tension adjustment mechanism comprising a handle, a collar, and an adjustment nut. The adjustment nut is centrally threaded and engages with a threaded shaft. The adjustment nut is positioned between the collar and the tension spring of the flex arm. The collar surrounds the shaft and comprises at least one pin that protrudes toward the adjustment nut. The adjustment nut comprises a plurality of radial slots each separately configured to receive a pin. The handle is connected to the collar and configured to rotate the collar to displace the adjustment nut along the shaft. The handle may be further configured to disengage the pin with a radial slot, rotate to align the pin with a different radial slot, and engage the pin with the newly aligned radial slot.

### FIELD

Embodiments of the present invention relate to tension adjustment in tension springs and more specifically, to tension adjustment mechanisms in flex arms or zero gravity arms.

### BACKGROUND

It is often necessary during dental and medical procedures to have objects such as lights or machines held or suspended in air. These objects can be heavy or may need to be placed in a specific location for aiding in the procedure. As such, flex arms, or zero gravity arms, are used to suspend objects at a desired location so as to enable an operator to utilize the object without holding the weight of the object.

Flex arms use tension springs to counter-balance the weight of the flex arm and objects being suspended. Since differently weighted and sized objects may be mounted on the flex arm, the tension of the tension springs may require adjusting. Tension adjustment of a typical flex arm is performed by a user with a tool, such as a screw driver or specialized tool, placed into an access point to tighten or loosen the tension in the tension spring.

Adjusting the tension in the tension springs of flex arms can be difficult and complex. Furthermore, current tension adjustment in flex arms requires additional tools that may be lost or difficult to use. For example, a common adjustment system for a flex arm includes first engaging a screw driver with a slotted tension nut through a small access point. Then, a user must rotate the screw driver to either tighten or loosen the tension in the tension spring. In addition to being difficult to accomplish, these systems may require a heightened amount of strength when the tension in the tension spring is high. Moreover, the slotted tension nut can become worn or stripped, making tightening or loosening the tension even more difficult.

### SUMMARY OF THE INVENTION

Embodiments of the present invention provide a tension adjustment mechanism that makes adjusting the tension of a tension spring in a flex arm easier and more manageable. In particular, a user of an embodiment of the present invention can adjust tension in the tension spring without the use of additional tools. Moreover, embodiments provide an aesthetically pleasing and safe flex arm with an easy to use tension adjustment mechanism. Further embodiments employ a wrench-type tightening and loosening mechanism that requires less strength for a user to adjust the tension.

Embodiments of the present invention are related to a tension adjustment mechanism for a tension spring in a flex arm. Example embodiments include a tension adjustment mechanism comprising a handle, a collar, and an adjustment nut. The adjustment nut is centrally threaded and engages with a threaded shaft. The adjustment nut is positioned between the collar and the tension spring of the flex arm. The collar surrounds the shaft and comprises at least one pin that protrudes toward the adjustment nut. The adjustment nut comprises a plurality of radial slots each separately configured to receive a pin. The handle is connected to the collar and configured to rotate the collar to displace the adjustment nut along the shaft. Rotating the handle one direction moves the adjustment nut toward the tension spring, thereby increasing the tension. Rotating the handle in the opposite direction moves the adjustment nut away from the tension spring, thereby decreasing the tension. The handle may be further configured to disengage the pin with a radial slot, rotate to align the pin with a different radial slot, and engage the pin with the newly aligned radial slot. As such, the tension adjustment mechanism may act as a ratchet-type adjustment mechanism to increase or decrease the tension in a tension spring.

Other embodiments of the present invention include a method for adjusting the tension in a tension spring for a flex arm using the tension adjustment mechanism. In some embodiments, the method comprises unfolding the handle and engaging the pin of the collar into a radial slot of the adjustment nut. The method further comprises rotating the collar to displace the adjustment nut along the shaft and thereby adjust the tension in the tension spring either tighten or loosen. Further, the method may also comprise disengaging the pin from the radial slot, rotating the handle to align the pin with a different radial slot, and engaging the pin with the newly aligned radial slot. The method may further comprise rotating the handle to adjust the tension in the tension spring again. If the tension is adequately adjusted, the method may comprise folding the handle and placing a cover back on the flex arm.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a flex arm, in accordance with some embodiments discussed herein;

FIG. 2 is a perspective view of a flex arm section, in accordance with some embodiments discussed herein;

FIG. 3 is a perspective view of a flex arm section with the housing removed, in accordance with some embodiments discussed herein;

FIG. 4 is a detail view of a tension adjustment mechanism attached to a flex arm section, in accordance with some embodiments discussed herein;

FIG. 4A is an exploded view of the tension adjustment mechanism of FIG. 4, in accordance with some embodiments discussed herein;

FIG. 4B is a detail view of the tension adjustment mechanism of FIG. 4, in accordance with some embodiments discussed herein;

FIG. 5 is a flow chart of a method for decreasing tension in a tension spring, in accordance with some embodiments discussed herein;

FIG. 6 is a detail view of a flex arm section with a tension adjustment mechanism, wherein the handle of the tension adjustment mechanism is disposed in the folded position, in accordance with some embodiments discussed herein;

FIG. 7 is a detail view of the flex arm section of FIG. 6, wherein the handle of the tension adjustment mechanism is disposed in the unfolded position, in accordance with some embodiments discussed herein;

FIG. 8 is a detail view of the flex arm section of FIG. 6, wherein the handle and collar of the tension adjustment mechanism are disposed in the disengaged position, in accordance with some embodiments discussed herein;

FIG. 9 is a detail view of the flex arm section of FIG. 6, wherein the handle has been rotated and the handle and collar of the tension adjustment mechanism are disposed in the disengaged position, in accordance with some embodiments discussed herein;

FIG. 10 is a detail view of the flex arm section of FIG. 6, wherein the handle and collar of the tension adjustment mechanism are disposed in the engaged position, in accordance with some embodiments discussed herein;

FIG. 11 is a detail view of the flex arm section of FIG. 6, wherein the handle of the tension adjustment mechanism is disposed in the folded position and the cover is partially positioned on the flex arm section, in accordance with some embodiments discussed herein; and

FIG. 12 is a flow chart of a method for increasing tension in a tension spring, in accordance with some embodiments discussed herein.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

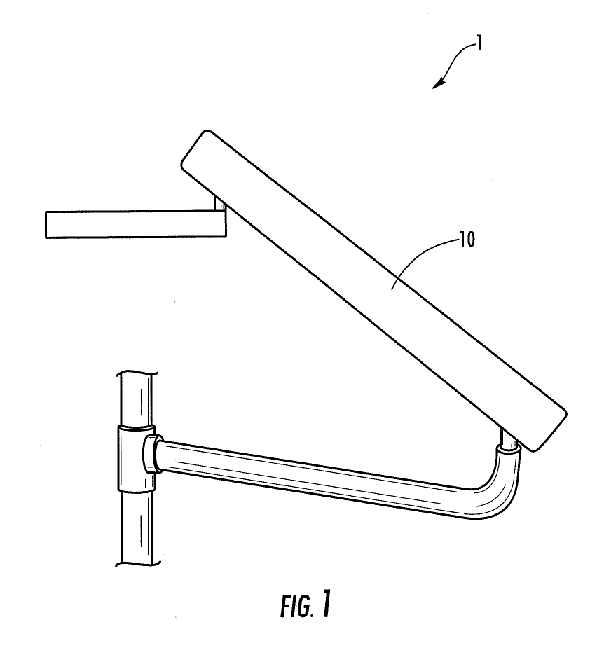

FIG. 1 shows a flex arm 1 often used in medical or dental procedures for holding or suspending objects, such as utensils, machines, or lights. The flex arm is also often referred to as a zero gravity arm and may also be used in other fields for suspending objects for ease of operation (e.g., construction, industry, etc.). Flex arms 1 comprise a flex arm section 10 that houses components for holding tension to counter-balance the weight of the objects being suspended. For example, flex arms 1, such as the one shown in FIG. 1, may be used to suspend a light to allow a hands free solution for providing light to a dental or medical procedure. Flex arms 1 are also configured to enable movement of the light, while maintaining the proper tension to suspend and hold the light. In such a manner, a dentist, doctor, or other operator may simply maneuver the suspended light to a desired location. Once in the desired location, the light will remain in place and allow the operator to benefit from the light without having to use their hands to hold the light. Similar uses are employed to position a tray or similar delivery system for medical or dental devices for a procedure. The operation of flex arms 1 and similar mechanisms are known in the art.

In some situations, tension in the flex arm may need to be adjusted, for example, to accommodate a differently weighted object. Thus, some flex arms provide a means for adjusting the tension in a tension spring in the flex arm section. Embodiments of the present invention are related to an improved means for adjusting tension in a tension spring in a flex arm.

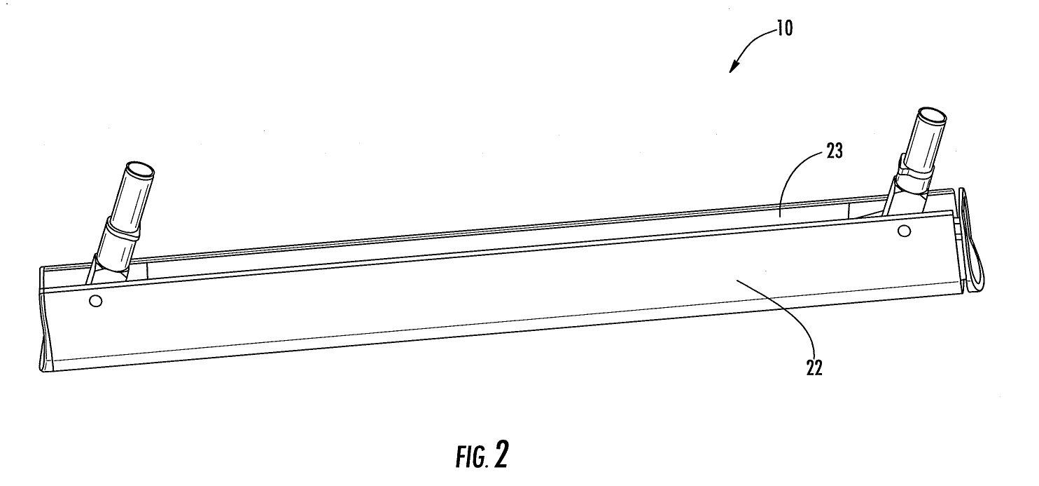

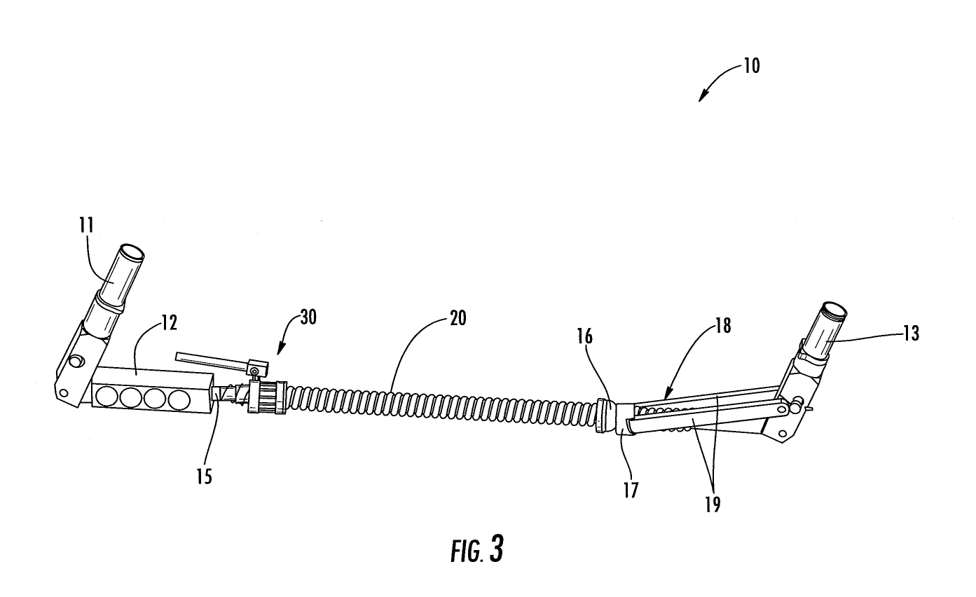

Some embodiments of the present invention can be used in a flex arm 1, and more particularly in the flex arm section 10 shown in FIGS. 2 and 3. FIG. 2 shows a flex arm section 10 detached from the remainder of the flex arm 1. As the flex arm 1 is often used in dental and medical offices, aesthetics and safety are both important. As such, a flex arm section 10 may comprise a housing 22 and a cover 23 to cover and hide the mechanical components necessary for operation of the flex arm 1.

FIG. 3 shows a flex arm section 10 with the housing 22 and cover 23 removed to reveal the working components. In the depicted embodiment, the flex arm section 10 comprises a shaft 15 and two knuckle arms 11, 13. The knuckle arms 11, 13 permit connection to other sections of the flex arm 1 or the object to be suspended. The shaft 15 extends the length of the flex arm section 10 and is pivotally connected to the knuckle arms 11, 13. At least one knuckle arm 13 may be configured to connect to the object to be suspended. That knuckle arm 13 is also connected to a yoke 18. The yoke 18 comprises two yoke rods 19 and a yoke collar 17. The yoke collar 17 surrounds the shaft 15 and is positioned adjacent to a bushing 16. The bushing 16 also surrounds the shaft 15 and is positioned between a main tension spring 20 and the yoke 18. The main tension spring 20 may surround the shaft 15 and is configured to transfer tension to the yoke 18 and the knuckle arm 13 through the bushing 16. The flex arm section 10 may also comprise a brake block 12 configured to prevent over tension and act as a safety feature.

An object is suspended by the flex arm 1 and the flex arm section 10 through a counter-balance of force created by the tension in the tension spring 20. The tension of the tension spring 20 passes through the bushing 16 to the yoke collar 17 and yoke rods 19. The yoke rods 19 hold the position of the knuckle arm 13 with the tension transferred from the tension spring 20 and, thus, the object will remain stationary and suspend from the desired location.

To permit maneuverability and/or suspension of any weighted or sized object, the tension spring 20 may be tightened or loosened depending on object's weight and/or position. Prior art flex arms require additional tools to adjust the tension in the tension spring of the flex arm. Thus, adjustment of the tension is often complex, requires additional parts, requires additional space, and may be difficult to perform with a patient in the room. Embodiments of the present invention provide a tension adjustment mechanism 30 for adjustment of the tension spring 20 in the flex arm section 10. In particular, embodiments of the present invention allow for, among other advantages, easy and tool-free adjustment of the tension in the tension spring 20. As described herein, the tension adjustment mechanism 30 is described with respect to a tension spring 20 of a flex arm 1, however, the tension adjustment mechanism 30 may be used in other apparatus including a tension spring 20, such as zero gravity arms or other suspension machines.

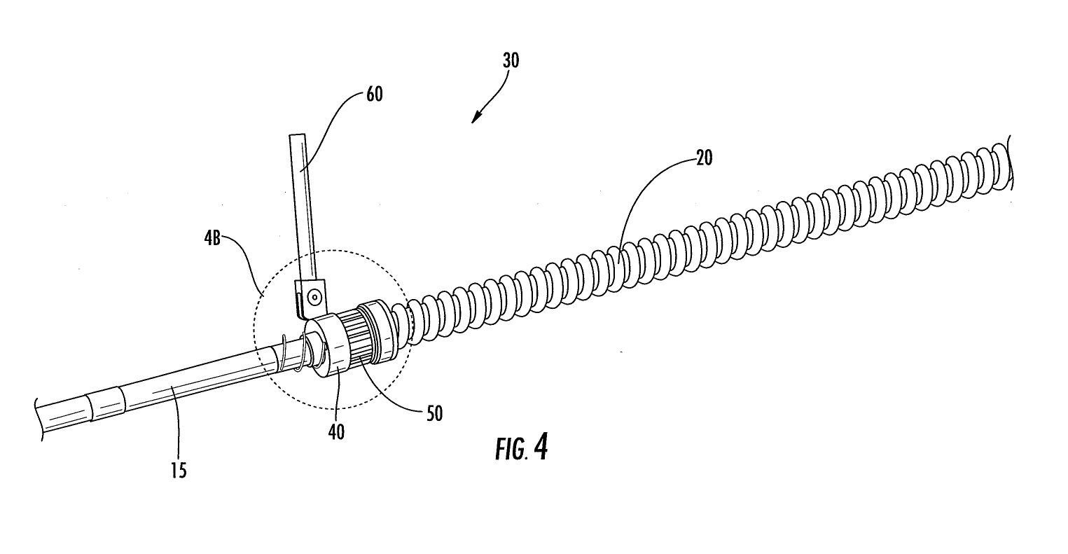

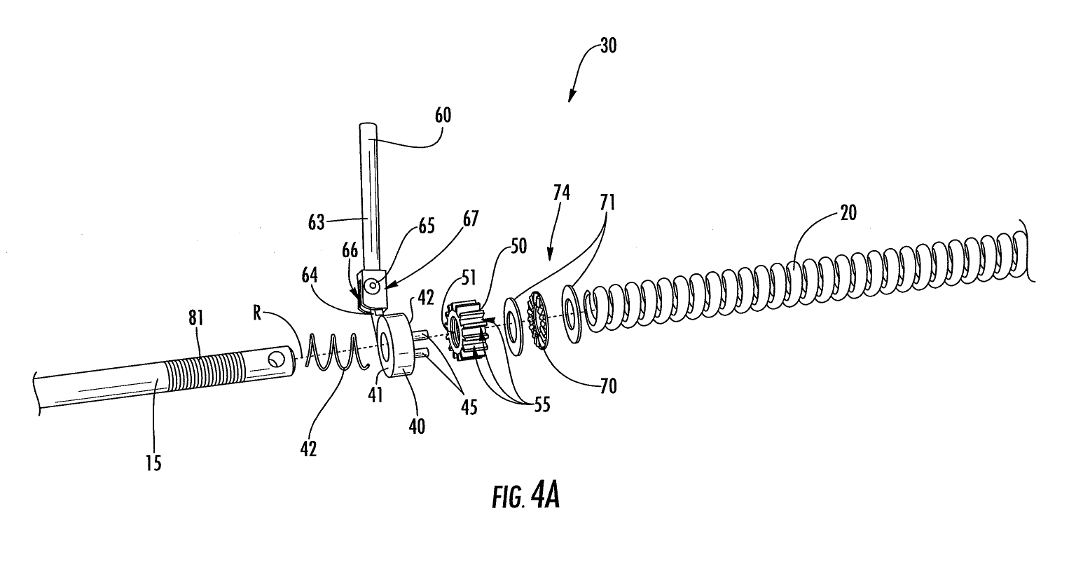

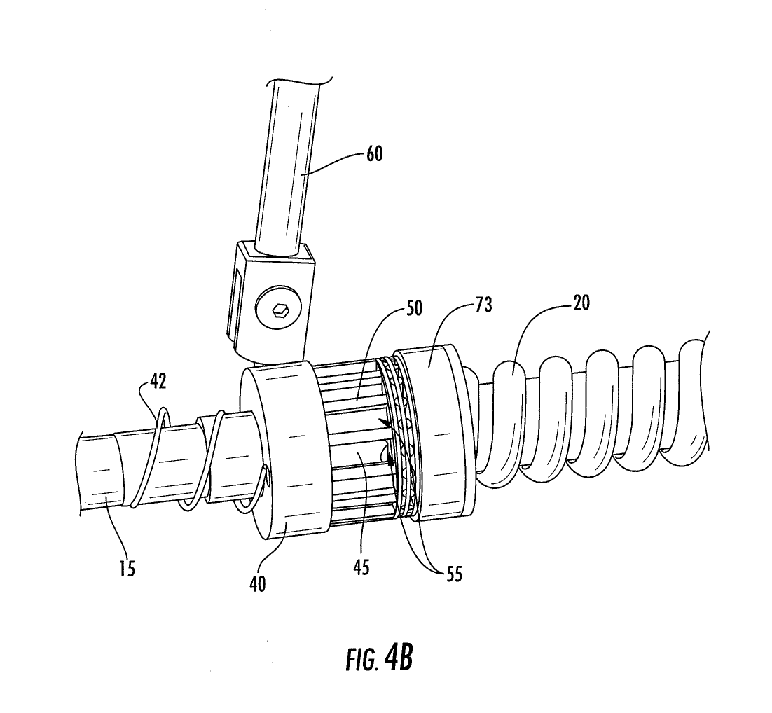

FIG. 4 shows one embodiment of the tension adjustment mechanism 30. In the depicted embodiment, the tension adjustment mechanism 30 comprises a handle 60, an adjustment nut 50, and a collar 40.

With further reference to FIG. 4A, which illustrates an exploded view of the tension adjustment mechanism 30, the collar 40 may comprise a central rotational axis R and two opposing faces 41, 42 perpendicular to the axis R. The collar 40 may also be configured to surround the shaft 15 and may comprise at least one pin 45 protruding from one face 42 of the collar 40. In some embodiments, the at least one pin 45 may be configured parallel to the axis R. In the depicted embodiment, the collar 40 comprises two pins 45.

The adjustment nut 50 may comprise a central opening and a central rotational axis R. The adjustment nut 50 may be positioned between the collar 40 and the tension spring 20 and may be configured to surround the shaft 15. In the depicted embodiment, the adjustment nut 50 is positioned between the collar 40 and a thrust bearing assembly 74, comprising a thrust bearing 70 and two opposing washers 71. In some embodiments, the shaft 15 may comprise a threaded external portion 81. In other embodiments, the shaft 15 may be fully externally threaded. Further, the adjustment nut 50 may comprise a central threaded portion 51 configured to engage with the threaded external portion 81 of the shaft 15. In such a way, for threading and displacement purposes, the adjustment nut 50 may act like a nut on the screw portion of the shaft 15, as would be apparent to one of ordinary skill in the art.

The adjustment nut 50 may also comprise a plurality of radial slots 55. The radial slots 55 may be configured to each separately receive a pin 45 of the collar 40. In the depicted embodiment, the adjustment nut 50 comprises a plurality of radial slots 55 configured around the circumference of the adjustment nut 50. As will be apparent to one of ordinary skill in the art, each radial slot 55 is configured to engage with a pin 45 such that rotation of the adjustment nut 50 is possible through manipulation of the pin 45 and/or collar 40.

The handle 60 is connected to the collar 40 and is configured to allow a user to adjust the tension of the tension spring 20. The handle 60 is configured to at least partially rotate the collar 40 to displace the adjustment nut 50 along the shaft 15 when at least one pin 45 is engaged with at least one of the plurality of radial slots 55. In particular, as shown in FIG. 4B, the collar 40 may be displaced in an engaged position with the adjustment nut 50 when at least one pin 45 is engaged or received by at least one of the plurality of radial slots 55. When engaged, a user can rotate the handle 60, which rotates that collar 40 and pin 45, thereby causing the adjustment nut 50 to rotate. In some embodiments, the rotation of the adjustment nut 50 displaces or threads the adjustment nut 50 along the shaft 15. Therefore, depending on the direction of rotation, the adjustment nut 50 can displace closer to or farther away from the tension spring 20, such that the tension in the tension spring is increased or decreased.

With reference to FIG. 4A, the handle 60 may also be configured to disengage the at least one pin 45 of the collar 40 from the radial slots 55 of the adjustment nut 50. For example, the handle 60 may be configured to pull the pin 45 out of the radial slot 55, such that the collar 40 and handle 60 are in a disengaged position. Moreover, the handle may be configured to rotate the collar 40 so that the pin 45 may align with a different radial slot 55. Furthermore, the handle 60 may be configured to engage the pin 45 in that different radial slot 55. In such a manner, a user can manipulate the handle 60 to engage the collar 40 with the adjustment nut 50 and then rotate the collar 40 to adjust the tension in the tension spring 20. Further, the user can disengage the collar 40 from the adjustment nut 50, rotate the handle 60 and collar 40, engage the collar 40 and pin 45 with the adjustment nut 50 via a different radial slot 55, and then rotate the collar 40 again to adjust the tension in the tension spring 20. Thus, the tension adjustment mechanism 30 as described herein can be used similar to a wrench-type mechanism to adjust the tension in the tension spring 20 of the flex arm section 10.

Additionally, the handle 60 may be pivotally connected and may comprise a folded position and unfolded position. In some embodiments, at least a portion of the handle 60 may be positioned substantially parallel to the axis R when disposed in the folded position. Moreover, the handle 60 may be configured to at least partially rotate the collar 40 when disposed in the unfolded position. For example, in the depicted embodiment of FIG. 4A, the handle 60 comprises an upper portion 63, a lower portion 64, and a hinge 65. The hinge 65 may pivotally connect the upper portion 63 and the lower portion 64. The upper portion 63 may also comprise an opening 66 and a backing 67 near the hinge 65. The opening 66 may be configured such that the upper portion 63 may pivot to a position substantially parallel to the rotational axis R. The backing 67 may be configured to prevent the upper portion 63 from pivoting in that direction. Thus, the backing 67 allows the handle 60 to be stable and rigid for use, such that the handle 60, in the unfolded position, may at least partially rotate the collar 40.

Additionally, the tension adjustment mechanism 30 may also comprise a biasing element 42 configured to bias the collar 40 and the at least one pin 45 of the collar 40 to engage at least one of the plurality of radial slots 55 of the adjustment nut 50. In the depicted embodiment, the biasing element 42 is a spring that surrounds the shaft 15 and biases the collar 40 toward the adjustment nut 50. In some embodiments, the biasing element 42 urges the pin 45 into a radial slot 55 thereby helping a user properly engage the pin 45 in the radial slots 55.

The tension adjustment mechanism 30 may further comprise a thrust bearing assembly 74. The thrust bearing assembly 74 may comprise a thrust bearing 70 and two opposing washers 71. The thrust bearing 70 is known in the art and reduces friction created by the rotation of the adjustment nut 50 during adjustment of the tension in the tension spring 20. In some embodiments, as shown in FIG. 4B, the tension adjustment mechanism 30 may also comprise a spacer 73 for further protection and reduction in friction.

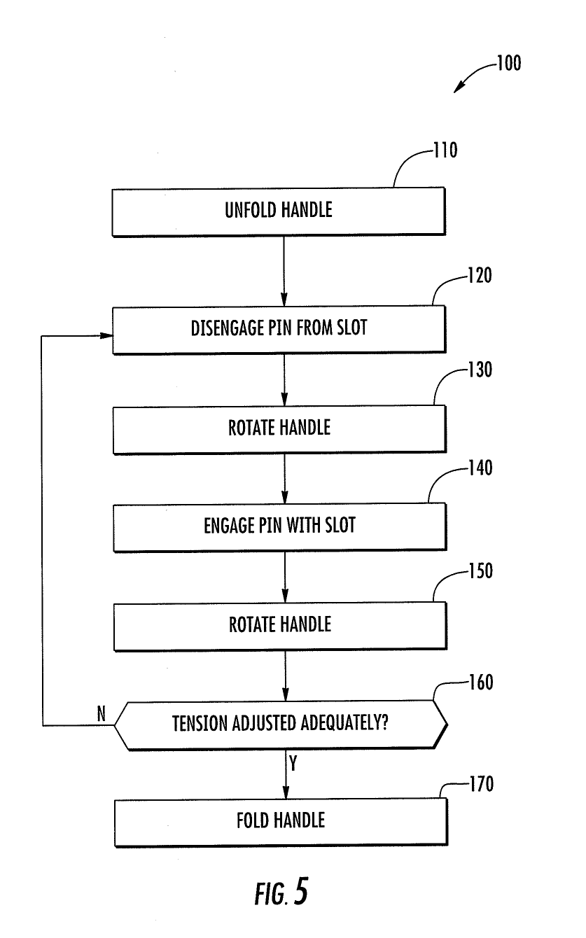

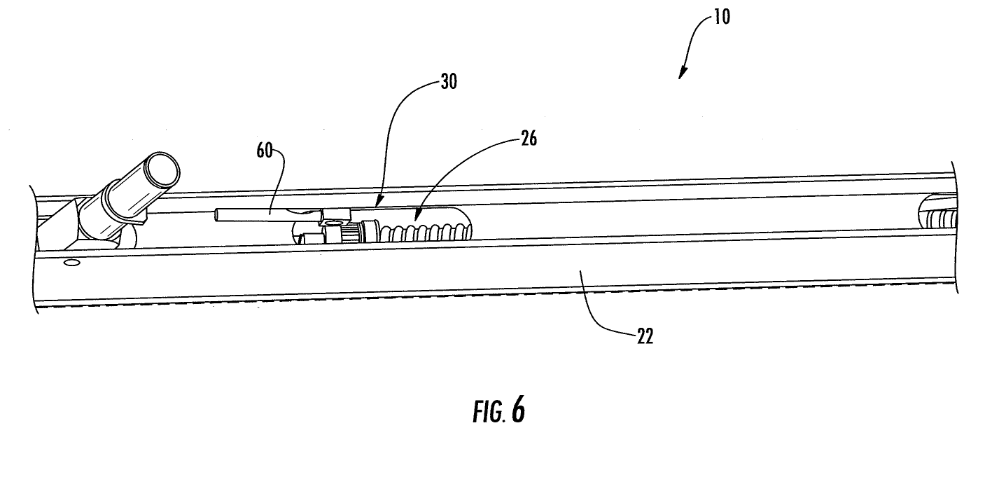

FIG. 5 illustrates a method 100 for decreasing tension in a tension spring of a flex arm using embodiments of the tension adjustment mechanism 30 described herein. The decreasing tension method 100 is further referenced with FIGS. 6-10, which illustrate the interaction of the tension adjustment mechanism 30 inside a flex arm section 10 with the housing 22 attached. In the depicted embodiments, the tension adjustment mechanism 30 comprises two pins 45, though as noted above, the method 100 may be performed using any of the embodiments described herein. Moreover, though rotational directions may be described below, it will be apparent to one of ordinary skill in the art, that the configuration of the tension adjustment mechanism may be converted to the opposite rotational directions (e.g., clockwise could be configured to decrease tension and counter-clockwise to increase tension).

In some embodiments, a user may remove the cover 23 (shown in FIG. 2) of the flex arm section 10 to gain access to the tension adjustment mechanism 30. As shown in FIG. 6, the housing 22 of the flex arm section 10 may comprise an opening 26 that allows access to the tension adjustment mechanism 30 once the cover 23 is removed while still protecting other mechanical components of the flex arm section 10, such as the tension spring 20.

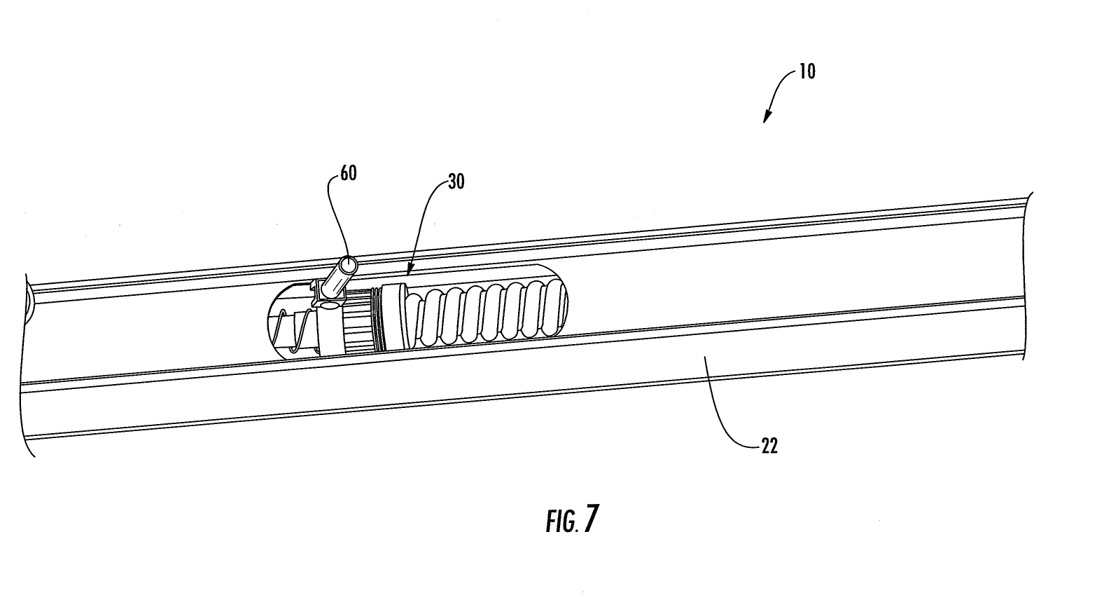

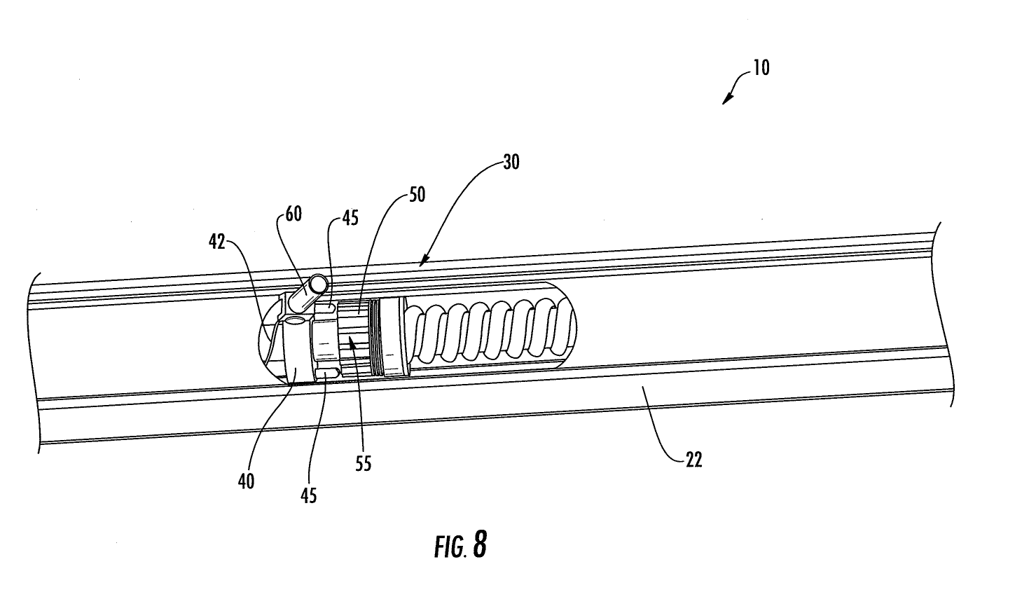

The decreasing tension method 100 may comprise, at step 110, unfolding the handle 60 from its folded position (shown in FIG. 6) and positioning the handle 60 into the unfolded position (shown in FIG. 7). Then with reference to FIG. 8, at step 120, the method 100 comprises disengaging the at least one pin 45 of the collar 40 from the one of the plurality of radial slots 55 of the adjustment nut 50. In some embodiments, the method may comprise manipulating the handle 60 so as to overcome the bias of a biasing element 42.

The method 100 may, at step 130, further comprise rotating the handle 60 to align the at least one pin 45 of the collar 40 with another at least one of the plurality of radial slots 55 of the adjustment nut 50. As shown in FIG. 8, the handle 60 may be rotated within the opening 26 in the housing 22 of the flex arm section 10 to align the pins 45 with two different radial slots 55. In the depicted embodiments, the handle 60 is rotated clockwise, though as described below with respect to the increasing tension method 200, and as apparent to one of ordinary skill in the art, the handle may rotate counter-clockwise.

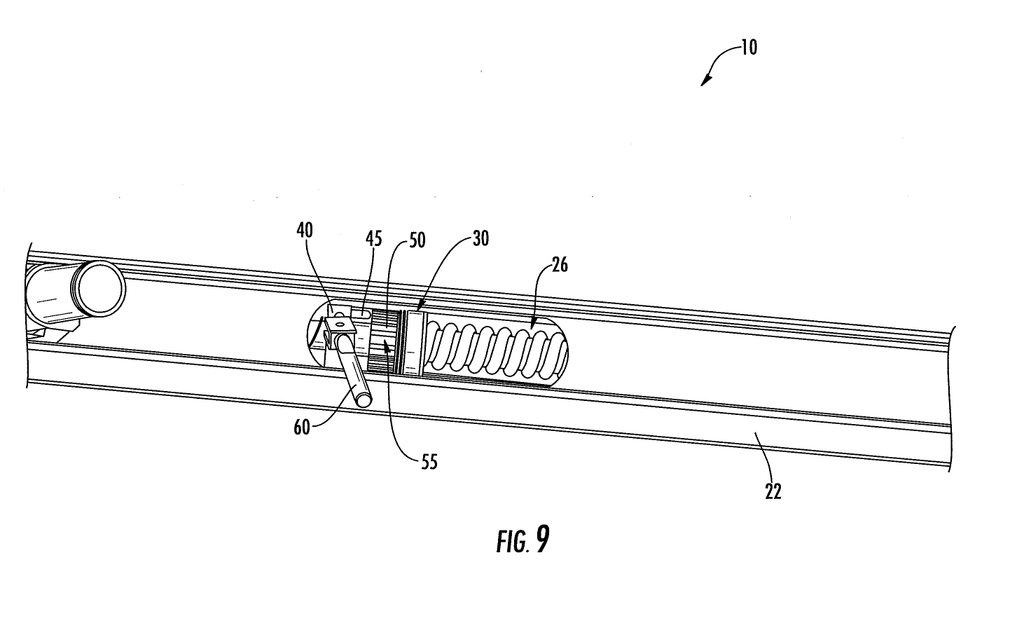

As shown in FIG. 9, with the at least one pin 45 aligned with at least one different radial slot 55, the decreasing tension method 100 may, at step 140, further comprise engaging the at least one pin 45 of the collar 40 with one of the plurality of radial slots 55 of the adjustment nut 50. In the depicted embodiment, the user may slide the pin 45 into the aligned radial slot 55.

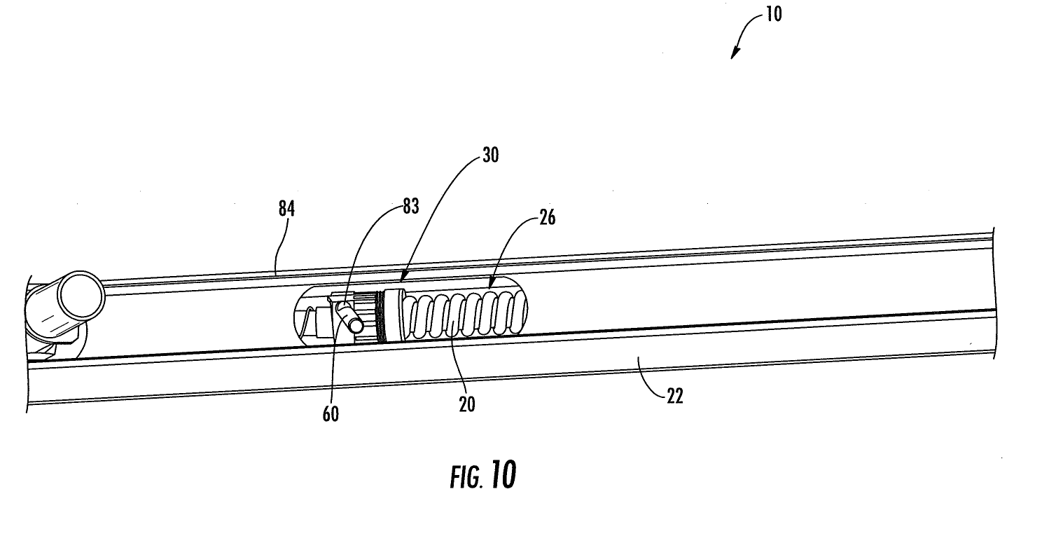

With the at least one pin 45 engaged with the at least one plurality of radial slots 55 (shown in FIG. 10), the method 100 may, at step 150, further comprise rotating the handle 60 to at least partially rotate the collar 40 to displace the adjustment nut 50 along the shaft 15, thereby decreasing the tension in the tension spring 20 of the flex arm section 10. In the depicted embodiment, the user may rotate the handle 60 counter-clockwise to decrease or release some of the tension in the tension spring 20 by displacing the adjustment nut 50 away from the tension spring 20. In some embodiments, the handle may further comprise a divot 83. The divot 83 is a portion of the handle 60 that has been removed to allow the handle 60 to rotate farther (i.e., increase the degree of rotation freedom for the handle and collar). For example, as shown in FIG. 10, the divot 83 allows the handle 60 to rotate farther as the divot 83 is configured to receive a portion of a wall 84 of the housing 22.

After rotating the handle to adjust the tension in the tension spring 20, the method 100 may further comprise determining if the tension has been adequately adjusted at step 160. If the tension has not been adequately adjusted, the method 100 may comprise returning to step 120 to further adjust the tension in the tension spring 20. In some embodiments, the tension may have decreased too much and thus the user may wish to increase the tension in the tension spring 20 such as described with respect to the increasing tension method 200. Thus, embodiments of the present invention allow a user to adjust the tension in the tension spring by increasing or decreasing tension appropriately, and the examples provided herein are non-limiting in such a regard.

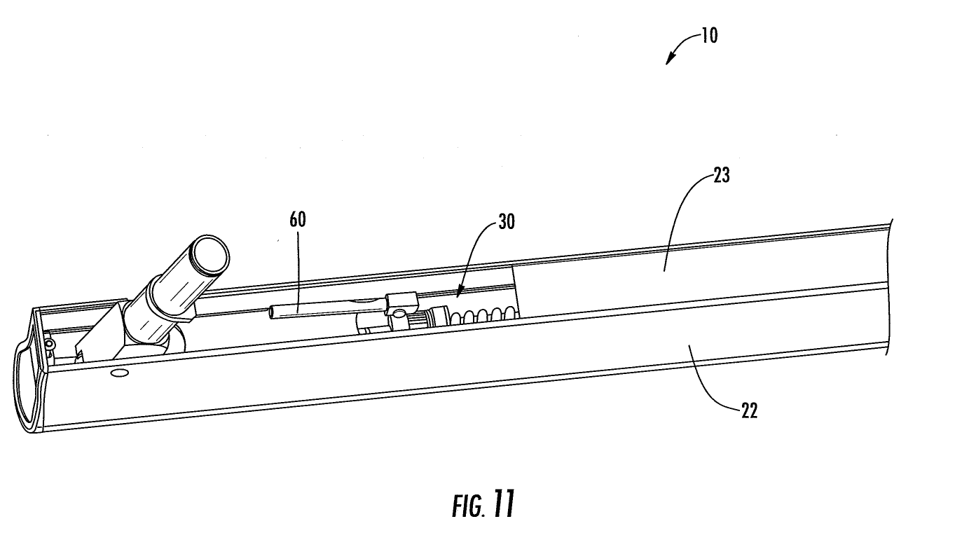

If the tension is adequately adjusted, the method 100 may, at step 170, further comprise folding the handle 60 to return the handle 60 to the folded position. In some embodiments, the method of adjusting the tension in the tension spring of a flex arm may further comprise placing the cover 23 on the housing 22 after positioning the handle in the folded position. As such, additional advantages of embodiments of the present invention include increased safety and aesthetic of a flex arm with a hidden tension adjustment mechanism. In particular, with reference to FIG. 11, the tension adjustment mechanism 30 may fit completely inside and be hidden under the cover 23 of the flex arm section 10.

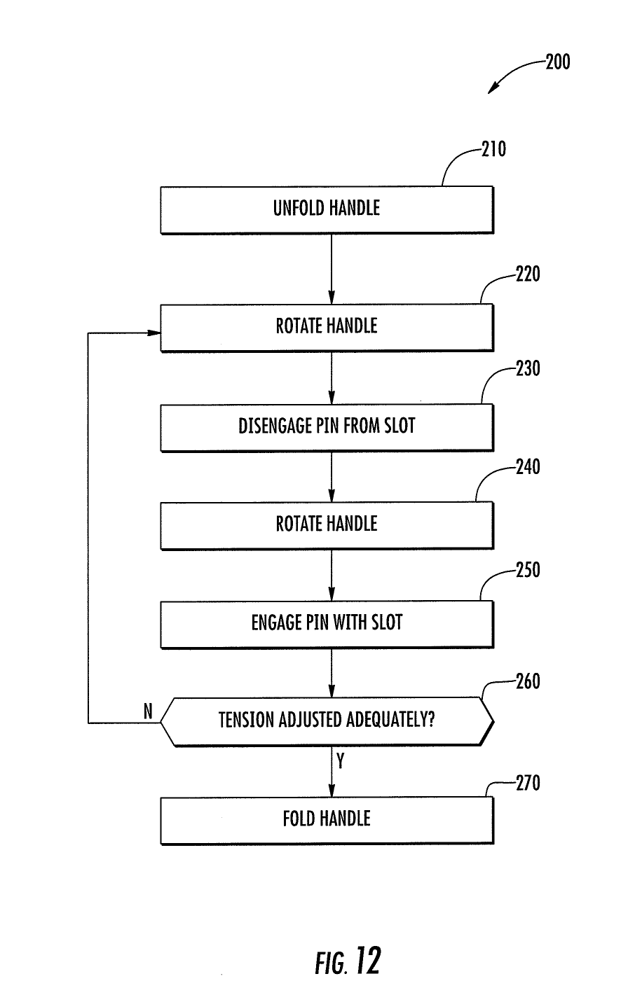

FIG. 12 illustrates a method for increasing tension in a tension spring of a flex arm 200 using embodiments of the tension adjustment mechanism 30 described herein. As detailed above, increasing and decreasing the tension in the tension spring can be used interchangeably and are not mutually exclusive.

The increasing tension method 200 comprises similar steps to the decreasing tension method 100 and merely changes the rotation direction of the handle for aligning the pin with the radial slot and for rotating the collar while the pin is engaged with the radial slot. For example, the increasing tension method 200 may comprise unfolding the handle at step 210. The method 200 may further comprise rotating the handle to decrease the tension in the tension spring at step 220. The method may further comprise disengaging at least one pin from at least one of the plurality of radial slots at step 230. The method may further comprise rotating the handle to align the at least one pin of the collar with another radial slot at step 240. Then, at step 250, the method 200 may comprise engaging the at least one pin with the aligned radial slot.

The increasing tension method 200 may further comprise determining if the tension has been adjusted adequately at step 260. If the tension has not been adjusted adequately, the method 200 may comprises returning to step 220 to repeat increasing the tension in the tension spring. If the tension has been adequately adjusted, the method 200 may further comprise folding the handle to the folded position at step 270.

Embodiments of the present invention make adjusting the tension in the tension spring of a flex arm easier and more manageable. In particular, a user of embodiments of the present invention can adjust tension in the tension spring without the use of additional tools. Moreover, some embodiments provide an aesthetically pleasing and safe flex arm, since the tension adjustment mechanism is neatly and safely contained within the housing of the flex arm.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included herein. Although specific terms are employed herein, they are used in a generic and descriptive sense only and not for purposes of limitation.

1. A tension adjustment mechanism for adjusting the tension in a tension spring, the tension adjustment mechanism comprising:
a collar surrounding a portion of a shaft, wherein the collar comprises a central rotational axis and two opposing faces perpendicular to the axis, and wherein the collar further comprises at least one pin protruding from one face of the collar parallel to the axis;
an adjustment nut positioned between the collar and the tension spring and surrounding a portion of the shaft, wherein the adjustment nut comprises a central threaded portion configured to engage with a threaded external portion of the shaft and a plurality of radial slots configured to each separately receive the at least one pin; and
a handle configured to be connected to the collar and configured to at least partially rotate the collar to displace the adjustment nut along the shaft when the at least one pin is engaged with at least one of the plurality of radial slots for adjusting the tension of the tension spring.

2. The tension adjustment mechanism according to claim 1, wherein the handle is further configured to disengage the at least one pin of the collar from at least one of the plurality of radial slots and engage the at least one pin in another at least one of the plurality of radial slots.

3. The tension adjustment mechanism according to claim 1, further comprising a biasing element configured to bias the at least one pin of the collar to engage at least one of the plurality of radial slots of the adjustment nut.

4. The tension adjustment mechanism according to claim 1, wherein the collar comprises two pins.

5. The tension adjustment mechanism according to claim 1, further comprising a thrust bearing positioned between the adjustment nut and the tension spring.

6. The tension adjustment mechanism according to claim 1, wherein the handle is pivotally connected and configured to be arranged in a folded position and an unfolded position, wherein at least a portion of the handle is positioned substantially parallel to the axis of the collar in the folded position, and wherein the handle is configured to at least partially rotate the collar in the unfolded position.

7. The tension adjustment mechanism according to claim 1, wherein the tension adjustment mechanism is configured to adjust the tension in the tension spring without the use of tools.

8. A flex arm comprising:
a tension spring;
a shaft comprising a threaded external portion; and
a tension adjustment mechanism comprising:
a collar surrounding a portion of the shaft, wherein the collar comprises at least one pin protruding from the collar;
an adjustment nut positioned between the collar and the tension spring and surrounding a portion of the shaft, wherein the adjustment nut comprises a central threaded portion configured to engage with the threaded external portion of the shaft and a plurality of radial slots configured to each separately receive the at least one pin; and
a handle configured to be connected to the collar and configured to at least partially rotate the collar to displace the adjustment nut along the shaft when the at least one pin is engaged with at least one of the plurality of radial slots for adjusting the tension of the tension spring.

9. The flex arm according to claim 8, wherein the handle is further configured to disengage the at least one pin of the collar from at least one of the plurality of radial slots and engage the at least one pin in another at least one of the plurality of radial slots.

10. The flex arm according to claim 8, wherein the tension adjustment mechanism further comprises a biasing element configured to bias the at least one pin of the collar to engage at least one of the plurality of radial slots of the adjustment nut.

11. The flex arm according to claim 8, wherein the collar comprises two pins.

12. The flex arm according to claim 8, wherein the tension adjustment mechanism further comprises a thrust bearing positioned between the adjustment nut and the tension spring.

13. The flex arm according to claim 8, wherein the handle is pivotally connected and configured to be arranged in a folded position and an unfolded position, wherein at least a portion of the handle is positioned substantially parallel to the axis of the collar in the folded position, and wherein the handle is configured to at least partially rotate the collar in the unfolded position.

14. The flex arm according to claim 8, wherein the tension adjustment mechanism is configured to adjust the tension in the tension spring without the use of tools.

15. A method for adjusting the tension in a tension spring, the method comprising:
engaging at least one pin of a collar with one of a plurality of radial slots of an adjustment nut, wherein the pin protrudes from the collar, and wherein the plurality of radial slots are configured to each separately receive the at least one pin; and
rotating a handle connected to the collar to at least partially rotate the collar to displace the adjustment nut along a shaft when the at least one pin is engaged with the at least one of the plurality of radial slots for adjusting the tension of the tension spring, wherein the adjustment nut and the collar surround a portion of the shaft, wherein the adjustment nut is positioned between the collar and the tension spring, and wherein the adjustment nut comprises a central threaded portion configured to engage with a threaded external portion of the shaft.

16. The method according to claim 15, further comprising:
disengaging the at least one pin of the collar from the at least one of the plurality of radial slots of the adjustment nut;
rotating the handle to align the at least one pin of the collar with another at least one of the plurality of radial slots of the adjustment nut; and
repeating the steps of engaging at least one pin of a collar with one of a plurality of radial slots of the adjustment nut and rotating the handle to at least partially rotate the collar to displace the adjustment nut along the shaft.

17. The method according to claim 15, further comprising unfolding the handle before engaging the at least one pin, wherein the handle is pivotally connected to the collar.

18. The method according to claim 17, further comprising folding the handle after rotating the handle to at least partially rotate the collar to displace the adjustment nut along the shaft.
